(19) United States
(12) Patent Application Publication
(10) Pub. No.: US 2022/0229391 A1
(43) Pub. Date: Jul. 21, 2022

(54) ELASTIC BODY FOR BLADES AND CLEANING BLADE USING THIS ELASTIC BODY

(71) Applicant: BANDO CHEMICAL INDUSTRIES, LTD., Hyogo (JP)

(72) Inventor: Ken HIROTOMI, Hyogo (JP)

(73) Assignee: BANDO CHEMICAL INDUSTRIES, LTD., Hyogo (JP)

(21) Appl. No.: 17/614,549

(22) PCT Filed: May 31, 2019
(86) PCT No.: PCT/JP2019/021659

§ 371 Date: Nov. 28, 2021

(51) Int. Cl. G03G 21/00; C08G 18/42; C08G 18/76; C08G 18/10

(52) U.S. Cl. CPC G03G 21/0017; C08G 18/10; C08G 18/7642; C08G 18/4277

(57) ABSTRACT

The present invention addresses the issue of providing a cleaning blade having excellent durability. An elastic body for blades is provided that has an abutting section that comprises a heat-curable polyurethane urea that is a reaction product of at least a polyol, a polyisocyanate, and a curing agent including a diaminobenzoic acid ester indicated by general formula (1).

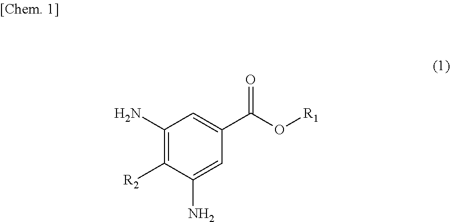

### TECHNICAL FIELD

The present invention relates to an elastic body for blades that has an abutting section that comprises a heat-curable polyurethane urea, the elastic body being used for blades of electrophotographic devices.

### BACKGROUND ART

In electrophotographic devices such as copiers, printers, facsimile machines and multifunction machines, blades such as a cleaning blade, a development blade, a conductive blade, a polishing blade and an application blade are used. A blade comprises an elastic body and a support member, and a heat-curable polyurethane having appropriate hardness and elasticity is normally used for the elastic body.

In recent years, there has been a demand for extension of the service life of each member such as a blade in order to reduce the exchange frequency of a photoreceptor unit in electrophotographic devices. In addition, there has been another demand for elastic bodies for blades to contribute to extension of the service lives of the entire systems such as prevention of filming (fixation) of toners, external additives and the like to photoreceptor drums and reduction in wear of photoreceptor drums.

In order to extend the service lives of blades, there has been a proposal of a method for increasing the hardness of an abutting section that comes into contact with photoreceptors and the like, and, for example, Patent Literature 1 proposes an elastic body in which an edge layer (abutting section) and a base layer (rear surface section) are formed of polyurethanes having different material qualities and only the hardness of the edge layer is increased. In addition, Patent Literature 2 proposes an elastic body in which only an image carrier abutting section comprising a sole polyurethane is impregnated with an isocyanate compound and only the hardness of the image carrier and the abutting section is increased.

### CITATION LIST

### Patent Literature

[Patent Literature 1]
Japanese Patent No. 4818945
[Patent Literature 2]
Japanese Patent Laid-Open No. 2005-156696

### SUMMARY OF INVENTION

### Technical Problem

The present invention addresses the issue of providing a cleaning blade having excellent durability.

### Solution to Problem

Means for solving the issue of the present invention is as described below.

1. An elastic body for blades, in which an abutting section comprises a heat-curable polyurethane urea that is a reaction product of at least a polyol, a polyisocyanate, and a curing agent including a diaminobenzoic acid ester indicated by the following general formula (1).

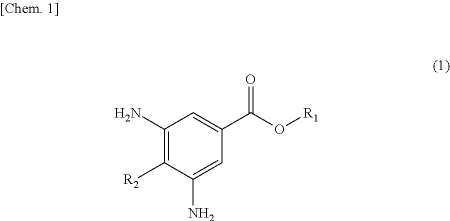

(In the formula, R₁ indicates a linear or branched alkyl group having 1 to 12 carbon atoms that may be substituted with a halogen atom, a linear or branched unsaturated hydrocarbon group having 3 to 10 carbon atoms that may be substituted with a halogen atom, or a phenyl group that may be substituted with a linear or branched alkyl group having 1 to 4 carbon atoms or a halogen atom, and

R₂ indicates a hydrogen atom, a halogen atom or a linear or branched alkyl group having 1 to 4 carbon atoms that may be substituted with a halogen atom.)
2. The elastic body for blades according to 1., in which R₂ is a chlorine atom or a methyl group.
3. The elastic body for blades according to 1, or 2., in which the diaminobenzoic acid ester is isobutyl 3,5-diamino-4-chlorobenzoate indicated by the following general formula (2).

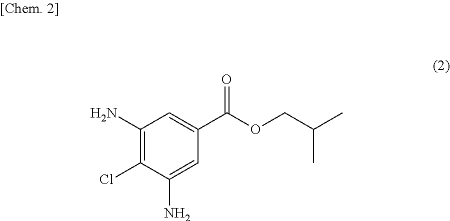

4. The elastic body for blades according to any one of 1. to 3., comprising, as the curing agent, a polyhydric alcohol.
5. The elastic body for blades according to 4., comprising, as the polyhydric alcohol, trimethylolpropane.
6. The elastic body for blades according to 4., or 5., in which a mole ratio (—NH₂:—OH) between active hydrogen groups in the diaminobenzoic acid ester and the polyhydric alcohol is within a range of 95 to 5:5 to 95.
7. The elastic body for blades according to any one of 1. to 6., in which a rear surface section comprises any of a heat-curable polyurethane urea, a heat-curable polyurethane and a heat-curable polyurea having a different composition from the abutting section.
8. A cleaning blade for electrophotographic devices, in which the elastic body for blades according to any one of 1. to 7. is mounted in a support member.

### Advantageous Effects of Invention

The elastic body for blades of the present invention has an abutting section that comprises a heat-curable polyurethane urea for which a specific diaminobenzoic acid ester is used as a curing agent and has excellent durability. For polyurethane urea, an amino-based compound is used as a curing agent, normally, the reaction is fast, and the handleability is poor.

For the heat-curable polyurethane urea that is used in the present invention, a specific diaminobenzoic acid ester is used, which makes the progress of the reaction slow and the handleability excellent.

### BRIEF DESCRIPTION OF DRAWINGS

FIG. 1 is a schematic view of an elastic body for blades in which an abutting section and a rear surface section are different compositions.

### DESCRIPTION OF EMBODIMENTS

### Elastic Body for Blades

In an elastic body for blades of the present invention (hereinafter, also simply referred to as “elastic body”), an abutting section comprises a specific heat-curable polyurethane urea including a diaminobenzoic acid ester as a curing agent.

The elastic body for blades is 5 mm or more and 20 mm or less in width and approximately 1 mm or more and 3 mm or less in thickness. In addition, the length of the elastic body is appropriately selected according to the width of a photoreceptor drum with which the elastic body comes into contact, that is, the width of printing paper and is approximately 220 mm in the case of using A4 size paper.

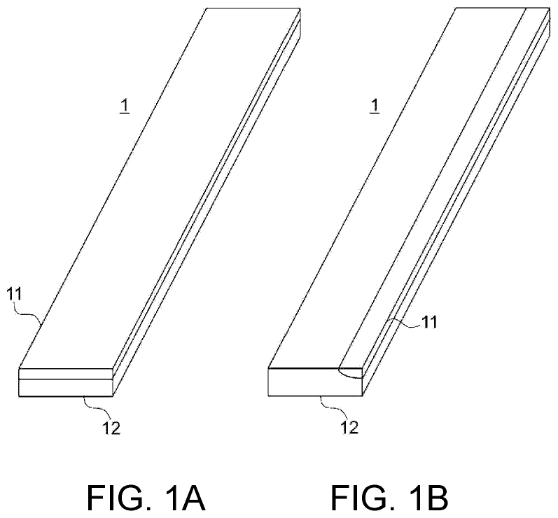

In the elastic body of the present invention, the abutting section needs to be composed of a specific heat-curable polyurethane urea, the entire elastic body may be composed of this specific heat-curable polyurethane urea, and a rear surface section may be composed of a heat-curable polyurethane urea, a heat-curable polyurethane, a heat-curable polyurea or the like having a composition different from the heat-curable polyurethane urea that composes the abutting section. As an elastic body in which an abutting section 11 and a rear surface section 12 are different compositions, a structure in which the abutting section 11 is fully provided on one surface of an elastic body 1 (for example, FIG. 1A) and a structure in which the abutting section 11 is provided along only one long side of the elastic body 1 (for example, FIG. 1B) can be exemplified. In a case where the abutting section and the rear surface sections are made of different compositions, the abutting section and the rear surface section preferably have different colors in order for improvement in workability and reduction of work mistakes at the time of joining the elastic body and a support member.

### Polyol

A polyol that is used in the present invention is not particularly limited, and it is possible to use polyether polyols, polyester polyols, polycarbonate polyols and the like. In addition, two or more thereof can also be used in combination.

Examples of the polyether polyols include polyethylene glycol, polypropylene glycol, polytetramethylene glycol and the like.

Possible examples of the polyester polyols include polyester polyols that can be obtained by reacting dicarboxylic acids and glycols according to general methods.

Examples of the dicarboxylic acids include aromatic dicarboxylic acids such as terephthalic acid, isophthalic acid and 2,6-naphthalenedicarboxylic acid, aliphatic dicarboxylic acids such as adipic acid, azelaic acid and sebacic acid, oxycarboxylic acids such as oxybenzoic acid, ester-forming derivatives thereof and the like. These may be used singly or two or more thereof may be jointly used.

Examples of the glycols include aliphatic glycols such as ethylene glycol, 1,4-butanediol, diethylene glycol, neopentyl glycol, 3-methyl-1,5-pentanediol, 1,9-nonanediol and triethylene glycol, alicyclic glycols such as 1,4-cyclohexanedimethanol, aromatic diols such as p-xylenediol, polyoxyalkylene glycols such as polyethylene glycol, polypropylene glycol and polytetramethylene glycol and the like. These may be used singly or two or more thereof may be jointly used.

Possible examples of other polyester polyols include polyester polyols that can be obtained by the ring-opening polymerization of a lactone using a diol as an initiator.

Examples of the diol include ethylene glycol, propylene glycol, 1,3-propylene glycol, 1,3-butanediol, 1,4-butanediol, 1,5-pentanediol, 3-methyl-1,5-pentanediol, neopentyl glycol, diethylene glycol, 4-oxa-2,6-heptanediol, 4-oxaheptane-1,7-diol, 1,10-decanediol and the like. These may be used singly or two or more thereof may be jointly used.

Examples of the lactone include β-propiolactone, γ-butyrolactone, δ-valerolactone, ε-caprolactone, β-methyl-δ-valerolactone and the like. These may be used singly or two or more thereof may be jointly used.

Examples of the polycarbonate polyols include reaction products of a dialkyl carbonate and a diol.

Examples of the dialkyl carbonate include dialkyl carbonates such as dimethyl carbonate and diethyl carbonate, diaryl carbonates such as diphenyl carbonate, alkylene carbonates such as ethylene carbonate and the like. These may be used singly or two or more thereof may be jointly used.

Examples of the diol include 1,4-butanediol, diethylene glycol, 1,5-pentanediol, 1,6-hexanediol, 1,7-heptanediol, 1,8-octanediol, 2-methyl-1,8-octanediol, 1,9-nonanediol, 1,10-dodecanediol, 2-ethyl-1,6-hexanediol, 3-methyl-1,5-pentanediol, 2,4-dimethyl-1,5-pentanediol, neopentyl glycol, 1,3-cyclohexanediol, 1,4-cyclohexanediol, 1,4-cyclohexanedimethanol, 2,2′-bis(4-hydroxycyclohexyl)-propane and the like. These may be used singly or two or more thereof may be jointly used.

### Polyisocyanate

As the polyisocyanate that is used in the present invention, any polyisocyanates that have been conventionally used for the synthesis of polyurethanes can be used with no particular limitations, and examples thereof include diisocyanates such as 4,4′-diphenylmethane diisocyanate (MDI), 1,5-naphthalene diisocyanate (NDI), 4,4′-dicyclohexylmethane diisocyanate (hydrogenated MDI), carbodiimide-modified MDI, 2,4-toluene diisocyanate (2,4-TDI), 2,6-toluene diisocyanate (2,6-TDI), 3,3′-bitolylene-4,4′-diisocyanate, 3,3′-dimethyldiphenylmethane-4,4′-diisocyanate, 2,4-toluene diisocyanate uretidinedione (2,4-TDI dimer), metaphenylene diisocyanate, hexamethylene diisocyanate, isophorone diisocyanate, o-tolidine diisocyanate, xylene diisocyanate, paraphenylene diisocyanate and lysine diisocyanate, triisocyanates such as triphenylmethane-4,4′,4″-triisocyanate, polymeric MDI and the like. These may be used singly or two or more thereof may be jointly used.

### Curing Agent

In the elastic body for blades of the present invention, a curing agent including a diaminobenzoic acid ester indicated by the following general formula (1) is used. The heat-curable polyurethane urea for which this diaminobenzoic acid ester is used as the curing agent has high hardness and excellent durability compared with heat-curable polyurethanes for which an alcohol-based curing agent is used.

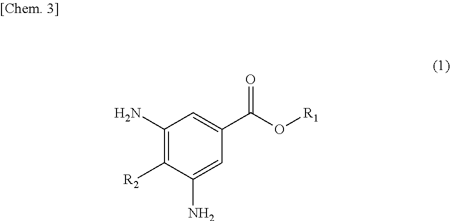

In the formula, R₁ indicates a linear or branched alkyl group having 1 to 12 carbon atoms that may be substituted with a halogen atom, a linear or branched unsaturated hydrocarbon group having 3 to 10 carbon atoms that may be substituted with a halogen atom, or a phenyl group that may be substituted with a linear or branched alkyl group having 1 to 4 carbon atoms or a halogen atom.

R₂ indicates a hydrogen atom, a halogen atom or a linear or branched alkyl group having 1 to 4 carbon atoms that may be substituted with a halogen atom.

In the general formula (1), R₂ is preferably a chlorine atom or a methyl group. The diaminobenzoic acid ester in which R₂ is a chlorine atom or a methyl group makes the progress rate of the curing reaction of the polyurethane urea appropriate and has excellent handleability, which is assumed to arise from the electron-donating properties and the balance with amines in steric effects of the chlorine atom or the methyl group.

As the curing agent of the present invention, furthermore, polyhydric alcohols can be used.

Examples of the polyhydric alcohols include aliphatic dihydric alcohols such as ethylene glycol, 1,2-propanediol, 1,3-propanediol, 2-methyl-1,3-propanediol, 2-butyl-2-ethyl-1,3-propanediol, 1,3-butanediol, 1,4-butandiol, neopentyl glycol (2,2-dimethyl-1,3-propanediol), 2-isopropyl-1,4-butanediol, 3-methyl-2,4-pentanediol, 2,4-pentanediol, 1,5-pentanediol, 3-methyl-1,5-pentanediol, 2-methyl-2,4-pentanediol, 2,4-dimethyl-1,5-pentanediol, 2,4-diethyl-1,5-pentanediol, 1,5-hexanediol, 1,6-hexanediol, 2-ethyl-1,3-hexanediol, 2-ethyl-1,6-hexanediol, 1,7-heptanediol, 3,5-heptanediol, 1,8-octanediol, 2-methyl-1,8-octanediol, 1,9-nonanediol and 1,10-decanediol; alicyclic dihydric alcohols such as cyclohexanedimethanol (for example, 1,4-cyclohexanedimethanol), cyclohexanediol (for example, 1,3-cyclohexanediol and 1,4-cyclohexanediol) and 2-bis(4-hydroxycyclohexyl)-propane; tri or higher hydric alcohols such as trimethylolethane, trimethylolpropane, hexitols, pentitols, glycerin, polyglycerin, 1,2,6-hexanetriol, 1,2,4-butanetriol, sorbitol, pentaerythritol and dipentaerythritol tetramethylolpropane; and the like. Among these, 1,4-butanediol is preferable as a dihydric alcohol, and trimethylolpropane is preferable as a trihydric alcohol.

In the curing agent, the blending ratio between the diaminobenzoic acid ester and the polyhydric alcohol is not particularly limited, but the diaminobenzoic acid ester and the polyhydric alcohol are preferably blended such that the mole ratio (—NH₂:—OH) between active hydrogen groups in the diaminobenzoic acid ester and the polyhydric alcohol falls within a range of 95 to 5:5 to 95 and more preferably blended such that the mole ratio falls within a range of 80 to 20:10 to 90. When the diaminobenzoic acid ester and the polyhydric alcohol in the curing agent are blended in this mole ratio, it is possible to enhance the durability of a heat-curable polyurethane urea to be obtained with almost no changes from conventional manufacturing steps.

### Catalyst

Furthermore, a catalyst can be used in order to accelerate the curing reaction. The catalyst is not particularly limited as long as urethanization of a hydroxyl group and an isocyanate group and urethanization of an amino group and an isocyanate group are accelerated, and it is possible to use trialkylamines such as triethylamine; tetraalkyldiamines such as N,N,N′,N′-tetramethyl-1,3-butanediamine; amino alcohols such as dimethylethanolamine; ethoxylated amines; ethoxylated diamines; ester amines such as bis(diethylethanolamine) adipate; triethylenediamine; cyclohexylamine derivatives such as N,N-dimethylcyclohexylamine; morpholine derivatives such as N-methylmorpholine and N-(2-hydroxypropyl)-dimethylmorpholine; amine-based compounds of a piperazine derivative or the like such as N,N′-diethyl-2-methylpiperazine or N,N′-bis-(2-hydroxypropyl)-2-methylpiperazine; dialkyltin compounds such as dibutyltin dilaurate and dibutyltin di(2-ethylhexoate); organic tin compounds such as stannous 2-ethylcaproate and stannous oleate; organic bismuth compounds such as bismuth 2-ethylhexanoate and bismuth neodecanoate; saturated aliphatic alkali metal salts that are salts of a saturated aliphatic acids such as formic acid, acetic acid, propionic acid, butyric acid, valeric acid, caproic acid, enanthic acid, caprylic acid, pelargonic acid, capric acid, lauric acid, myristic acid, pentadecylic acid, palmitic acid, margaric acid or stearic acid and an alkali metal such as lithium, sodium, potassium, rubidium, cesium or francium; temperature-sensitive catalysts such as diazabicyclononene (DBN), diazabicycloundecene (DBU) and phenolic resin salts, octylates, stearates, oleates, formates and p-toluenesulfonates thereof; and the like.

### Other Components

If necessary, an additive such as a filler, a stabilizer, a reactivity-accelerating catalyst, a softener, a processing aid, a mold release agent, a defoamer or a flame retardant can be mixed with an urethane resin composition that forms the heat-curable polyurethane urea.

In the heat-curable polyurethane urea that composes the abutting section of the present invention, the mole ratio of the active hydrogen groups in the polyol and the curing agent to isocyanate groups of the polyisocyanate or a prepolymer is preferably 0.8 or more and 1.0 or less, more preferably 0.85 or more and 0.98 or less and still more preferably 0.90 or more and 0.95 or less.

A method for manufacturing the elastic body for blades of the present invention is not particularly limited, and the elastic body can be manufactured by a centrifugal forming method, the method disclosed in Japanese Patent No. 4018033, Japanese Patent No. 4820161 and Japanese Patent No. 4974490 by the present applicant or the like.

In addition, such a forming method may be any of a one-shot method, a prepolymer method and a pseudo-prepolymer method.

In the one-shot method, the polyol, the polyisocyanate, the curing agent, the catalyst and the like are collectively injected and cured, thereby producing a compact of the heat-curable polyurethane urea.

In the prepolymer method, the polyol and a stoichiometrically excess amount of the polyisocyanate are reacted with each other to prepare a prepolymer having an isocyanate group at the terminal in advance, a predetermined amount of the curing agent, the catalyst and the like is mixed with the prepolymer, and the prepolymer is cured, thereby producing a compact of the heat-curable polyurethane urea.

In the pseudo-prepolymer method, some of the polyol is mixed with the curing agent in advance, a prepolymer is prepared using the remaining polyol and the polyisocyanate, and a mixture of the polyol and the curing agent that have been mixed together in advance and the catalyst or the like is mixed and cured, thereby producing a compact of the heat-curable polyurethane urea.

In the elastic body for blades of the present invention, the international rubber hardness degree of the abutting section is preferably 75 or more and 100 or less.

When the elastic body for blades of the present invention is joined to a support member made of metal or the like, it is possible to manufacture blades. The use of a blade of the present invention is not particularly limited, and the blade can be used as a cleaning blade, a development blade, a conductive blade, a polishing blade, an application blade and the like. Among these, the elastic body for blades of the present invention can be preferably used as a cleaning blade since the elastic body has excellent durability.

### EXAMPLES

### Prepolymer Manufacture Example 1

As a polyol, polycarprolactone (manufactured by Daicel Corporation, PLACCEL 220, molecular weight: 2000) was used. This polyol was dehydrated under reduced pressure at 110° C. for two hours. 4,4-Diphenylmethane diisocyanate (MDI) (manufactured by Tosoh Corporation, MILLIONATE MT) (103.2 parts by weight) was added as a polyisocyanate to this polyol (100 parts by weight) and reacted in a nitrogen atmosphere at 80° C. for three hours, thereby obtaining a prepolymer 1 (NCO %=15.0).

### Example 1

A predetermined amount of the prepolymer 1 was charged into a tank for a prepolymer in a casting machine, PLACCEL 220 as a polyol, isobutyl 3,5-diamino-4-chlorobenzoate and 1,1,1-trimethylolpropane as curing agents and bismuth 2-ethylhexanoate as a catalyst were charged into a tank for an active hydrogen-containing substance in predetermined amounts (liquid temperature: 70° C.), the components were mixed and stirred such that the weight ratio between the prepolymer and the polyol reached 100 parts by weight:71.43 parts by weight, the ratio between the number of amino groups in isobutyl 3,5-diamino-4-chlorobenzoate and the number of hydroxyl groups in 1,1,1-trimethylolpropane reached 95:5, the ratio of the total number of the amino groups and the hydroxyl groups to the number of isocyanate groups in the prepolymer reached 0.95 and the amount of the catalyst reached 500 ppm of the entire urethane urea, and the mixture was poured into a mold for continuous forming described in Japanese Patent No. 4974490. The amount of the mixture poured was set to an amount with which a mold cavity was exactly filled. The cross-sectional dimensions of the mold cavity were 25 mm in width and 2 mm in thickness, the mold temperature was set to 140° C., and the crosslinking time was set to 45 seconds.

An obtained continuous band-shaped sheet was cut in the length direction to 342 mm and then cut at the center in the width direction, thereby obtaining a 12.5 mm-wide strip.

### Example 2

Example 2 was carried out in the same manner as in Example 1 except that the ratio between the number of amino groups in isobutyl 3,5-diamino-4-chlorobenzoate and the number of hydroxyl groups in 1,1,1-trimethylolpropane was set to 80:20.

### Example 3

Example 3 was carried out in the same manner as in Example 1 except that the ratio between the number of amino groups in isobutyl 3,5-diamino-4-chlorobenzoate and the number of hydroxyl groups in 1,1,1-trimethylolpropane was set to 50:50.

### Example 4

Example 4 was carried out in the same manner as in Example 1 except that the ratio between the number of amino groups in isobutyl 3,5-diamino-4-chlorobenzoate and the number of hydroxyl groups in 1,1,1-trimethylolpropane was set to 10:90.

### Example 5

Example 5 was carried out in the same manner as in Example 1 except that the ratio between the number of amino groups in isobutyl 3,5-diamino-4-chlorobenzoate and the number of hydroxyl groups in 1,1,1-trimethylolpropane was set to 5:95.

### Example 6

Example 6 was carried out in the same manner as in Example 3 except that isobutyl 3,5-diamino-4-chlorobenzoate was changed to methyl 3,5-diamino-4-chlorobenzoate.

### Example 7

Example 7 was carried out in the same manner as in Example 3 except that isobutyl 3,5-diamino-4-chlorobenzoate was changed to dodecyl 3,5-diamino-4-chlorobenzoate.

### Example 8

Example 8 was carried out in the same manner as in Example 3 except that isobutyl 3,5-diamino-4-chlorobenzoate was changed to 2,2,2-trifluoroethyl 3,5-diamino-4-chlorobenzoate.

### Example 9

Example 9 was carried out in the same manner as in Example 3 except that isobutyl 3,5-diamino-4-chlorobenzoate was changed to 1-propenyl 3,5-diamino-4-chlorobenzoate.

### Example 10

Example 10 was carried out in the same manner as in Example 3 except that isobutyl 3,5-diamino-4-chlorobenzoate was changed to linalyl 3,5-diamino-4-chlorobenzoate.

### Example 11

Example 11 was carried out in the same manner as in Example 3 except that isobutyl 3,5-diamino-4-chlorobenzoate was changed to phenyl 3,5-diamino-4-chlorobenzoate.

### Example 12

Example 12 was carried out in the same manner as in Example 3 except that isobutyl 3,5-diamino-4-chlorobenzoate was changed to p-pentylphenyl 3,5-diamino-4-chlorobenzoate.

### Example 13

Example 13 was carried out in the same manner as in Example 3 except that isobutyl 3,5-diamino-4-chlorobenzoate was changed to 2′,4′-dichlorphenyl 3,5-diamino-4-chlorobenzoate.

### Example 14

Example 14 was carried out in the same manner as in Example 3 except that isobutyl 3,5-diamino-4-chlorobenzoate was changed to isobutyl 3,5-diaminobenzoate.

### Example 15

Example 15 was carried out in the same manner as in Example 3 except that isobutyl 3,5-diamino-4-chlorobenzoate was changed to isobutyl 4-methyl-3,5-diaminobenzoate.

### Example 16

Example 16 was carried out in the same manner as in Example 3 except that isobutyl 3,5-diamino-4-chlorobenzoate was changed to isobutyl 4-chloromethyl-3,5-diaminobenzoate.

### Example 17

Example 17 was carried out in the same manner as in Example 3 except that isobutyl 3,5-diamino-4-chlorobenzoate was changed to isobutyl 4-isobutyl-3,5-diaminobenzoate.

### Example 18

Example 18 was carried out in the same manner as in Example 3 except that 1,1,1-trimethylolpropane was changed to 1,1,1-trimethylolethane.

### Example 19

Example 19 was carried out in the same manner as in Example 3 except that 1,1,1-trimethylolpropane was changed to pentaerythritol.

### Example 20

Example 20 was carried out in the same manner as in Example 3 except that 1,1,1-trimethylolpropane was changed to dipentaerythritol.

### Comparative Example 1

Comparative Example 1 was carried out in the same manner as in Example 3 except that isobutyl 3,5-diamino-4-chlorobenzoate was changed to 1,4-butanediol.

### Comparative Example 2

Comparative Example 2 was carried out in the same manner as in Example 3 except that isobutyl 3,5-diamino-4-chlorobenzoate was changed to 3,5-dimethylthio-2,4-toluenediamine.

### Comparative Example 3

Comparative Example 3 was carried out in the same manner as in Example 3 except that isobutyl 3,5-diamino-4-chlorobenzoate was changed to 2,2′-3,3′-tetrachloro-4,4′-diaminodiphenyl methane.

### Prepolymer Manufacture Example 2

As a polyol, polytetramethylene glycol (manufactured by Hodogaya Chemical Co., Ltd., PTG2000SN, molecular weight: 2000) was used. This polyol was dehydrated under reduced pressure at 80° C. for two hours. 4,4-Diphenylmethane diisocyanate (MDI) (manufactured by Tosoh Corporation, MILLIONATE MT) (103.2 parts by weight) was added as a polyisocyanate to this polyol (100 parts by weight) and reacted in a nitrogen atmosphere at 80° C. for three hours, thereby obtaining a prepolymer 2 (NCO %=15.0).

### Examples 21 to 40

The components were poured into the center of a mold for continuous forming in the same formulations as in Examples 1 to 20 using a casting machine for an abutting section. The amount of the components poured was set to an approximate arc shape that was 10 mm in the width direction and 0.3 mm in the thickness direction.

A predetermined amount of the prepolymer 2 was charged into a tank for a prepolymer in a casting machine for a rear surface section, PTG2000SN, 1,4-butanediol and 1,1,1-trimethylolpropane as curing agents and 1,8-diazabicyclo(5,4,0)-undecene-7 as a catalyst were charged into a tank for a polyol in predetermined amounts (liquid temperature: 60° C.), the components were mixed and stirred such that the weight ratio between the prepolymer and the polyol reached 100 parts by weight:80 parts by weight, the ratio between the number of hydroxyl groups in 1,4-butanediol and the number of hydroxyl groups in 1,1,1-trimethylolpropane reached 50:50, the ratio of the total number of the hydroxyl groups to the number of isocyanate groups in the prepolymer reached 0.95 and the amount of the catalyst reached 1000 ppm of the entire urethane urea, and the mixture was poured into a mold for continuous forming. The amount of the mixture poured was set to an amount with which a mold cavity was exactly filled. Subsequently, strips were obtained in the same manner as described in Example 1. Elastic bodies for blades obtained in Examples 21 to 40 had a structure in which an abutting section was provided at only one corner portion of the elastic body as shown in FIG. 1B.

### Comparative Examples 4 to 6

Comparative Examples 4 to 6 were carried out in the same manner as in Examples 21 to 40 except that the same formulations as in Comparative Examples 1 to 3 were used as the formulations for abutting sections.

### <International Rubber Hardness Degree (IRHD)>

For the elastic bodies for blades manufactured in Examples 1 to 20 and Comparative Examples 1 to 3, the international rubber hardness degrees in the vicinity of the abutting sections were measured using an IRHD rubber hardness meter (manufactured by Hildebrand-GmbH) according to JIS K 6253-2.

For the elastic bodies for blades manufactured in Examples 21 to 40 and Comparative Examples 4 to 6, the international rubber hardness degrees of the rear surface sections were measured in the same manner. The results are shown in Tables 1 and 2. As the international rubber hardness degrees of the abutting sections in the elastic bodies for blades manufactured in Examples 21 to 40 and Comparative Examples 4 to 6, the values of the international rubber hardness degrees of the abutting sections of Examples 1 to 20 and Comparative Examples 1 to 3 in which the same heat-curable polyurethane urea or heat-curable polyurethane as in the respective abutting sections was used are shown.

### <Production of Cleaning Blades>

Polyurethane rubber elastic members of the Examples and the Comparative examples were joined to metal supports of a 2.0 mm-thick steel sheet using a dimer acid-based hot-melt adhesive, thereby producing cleaning blades.

### <Durability Evaluation>

These cleaning blades were mounted in a RICOH MP C2503 printer, and durability was evaluated by the following method.

A paper-passing test was carried out at 28° C. and 85% RH, and the durability was evaluated by the number of paper sheets passed until a defect of a toner-slipped image attributed to damage or deformation at the blade edge was caused. The number of paper sheets passed of 1000 was indicated by a unit ‘1k’. The results are shown in Tables 1 and 2.

TABLE 1

| | Example 1 | Example 2 | Example 3 | Example 4 | Example 5 | Example 6 | Example 7 | Example 8 |
|---|---|---|---|---|---|---|---|---|
| Kind of | Isobutyl | Isobutyl | Isobutyl | Isobutyl | Isobutyl | Methyl | Dodecyl | 2,2,2- |
| curing | 3,5-diamino- | 3,5-diamino- | 3,5-diamino- | 3,5-diamino- | 3,5-diamino- | 3,5-diamino- | 3,5-diamino- | Trifluoroethyl |
| agent | 4-chloro- | 4-chloro- | 4-chloro- | 4-chloro- | 4-chloro- | 4-chloro- | 4-chloro- | 3,5-diamino- |
| | benzoate/ | benzoate/ | benzoate/ | benzoate/ | benzoate/ | benzoate/ | benzoate/ | 4-chloro- |
| | TMP | TMP | TMP | TMP | TMP | TMP | TMP | benzoate/ |
| | | | | | | | | TMP |
| Curing agent | 95/5 | 80/20 | 50/50 | 10/90 | 5/95 | 50/50 | 50/50 | 50/50 |
| ratio | | | | | | | | |
| Abutting | 100 | 98 | 90 | 80 | 75 | 91 | 89 | 90 |
| section | | | | | | | | |
| hardness | | | | | | | | |
| (IRHD) | | | | | | | | |
| Durability | 150k | 190k | 200k | 190k | 150k | 195k | 195k | 190k |
| evaluation | | | | | | | | |

| | Example 9 | Example 10 | Example 11 | Example 12 | Example 13 | Example 14 | Example 15 | Example 16 |
|---|---|---|---|---|---|---|---|---|
| Kind of | 1-Propenyl | Linalyl | Phenyl | p-Pentylphenyl | 2′,4′- | Isobutyl | Isobutyl | Isobutyl |
| curing | 3,5-diamino- | 3,5-diamino- | 3,5-diamino- | 3,5-diamino- | Dichlorophenyl | 3,5-diamino- | 3,5-diamino- | 3,5-diamino- |
| agent | 4-chloro- | 4-chloro- | 4-chloro- | 4-chloro- | 3,5-diamino- | benzoate/ | 4-methyl- | 4-chloro- |
| | benzoate/ | benzoate/ | benzoate/ | benzoate/ | 4-chloro- | TMP | benzoate/ | methylbenzoate/ |
| | TMP | TMP | TMP | TMP | benzoate/ | | TMP | TMP |
| | | | | | TMP | | | |
| Curing agent | 50/50 | 50/50 | 50/50 | 50/50 | 50/50 | 50/50 | 50/50 | 50/50 |
| ratio | | | | | | | | |
| Abutting | 91 | 88 | 91 | 89 | 90 | 90 | 89 | 89 |
| section | | | | | | | | |
| hardness | | | | | | | | |
| (IRHD) | | | | | | | | |
| Durability | 195k | 190k | 190k | 190k | 190k | 190k | 190k | 190k |
| evaluation | | | | | | | | |

| | | | | | Comparative | Comparative | Comparative |
|---|---|---|---|---|---|---|---|
| | Example 17 | Example 18 | Example 19 | Example 20 | Example 1 | Example 2 | Example 3 |
| Kind of | Isobutyl | Isobutyl | Isobutyl | Isobutyl | 1,4- | 3,5- | 2,2′-3,3′- |
| curing | 3,5-diamino- | 3,5-diamino- | 3,5-diamino- | 3,5-diamino- | Butanediol/ | Dimethylthio-2,4- | Tetrachloro-4,4′- |
| agent | 4-isobutyl- | 4-chloro- | 4-chloro- | 4-chloro- | TMP | toluenediamine/ | diaminodiphenyl |
| | benzoate/ | benzoate/ | benzoate/ | benzoate/ | | TMP | methane/ |
| | TMP | TME | pentaerythritol | dipentaerythritol | | | TMP |
| Curing agent | 50/50 | 50/50 | 50/50 | 50/50 | 50/50 | 50/50 | 50/50 |
| ratio | | | | | | | |
| Abutting | 91 | 91 | 88 | 87 | 72 | 85 | 87 |
| section | | | | | | | |
| hardness | | | | | | | |
| (IRHD) | | | | | | | |
| Durability | 190k | 120k | 100k | 80k | 10k | 25k | 20k |
| evaluation | | | | | | | |

TABLE 2

| | Example 21 | Example 22 | Example 23 | Example 24 | Example 25 | Example 26 | Example 27 | Example 28 |
|---|---|---|---|---|---|---|---|---|
| Kind of | Isobutyl | Isobutyl | Isobutyl | Isobutyl | Isobutyl | Methyl | Dodecyl | 2,2,2 - |
| curing | 3,5-diamino- | 3,5-diamino- | 3,5-diamino- | 3,5-diamino- | 3,5-diamino- | 3,5-diamino- | 3,5-diamino- | Trifluoroethyl |
| agent for | 4-chloro- | 4-chloro- | 4-chloro- | 4-chloro- | 4-chloro- | 4-chloro- | 4-chloro- | 3,5-diamino- |
| abutting | benzoate/ | benzoate/ | benzoate/ | benzoate/ | benzoate/ | benzoate/ | benzoate/ | 4-chloro- |
| section | TMP | TMP | TMP | TMP | TMP | TMP | TMP | benzoate/ |
| | | | | | | | | TMP |
| Curing | 95/5 | 80/20 | 50/50 | 10/90 | 5/95 | 50/50 | 50/50 | 50/50 |
| agent | | | | | | | | |
| ratio for | | | | | | | | |
| abutting | | | | | | | | |
| section | | | | | | | | |
| Abutting | 100 | 98 | 90 | 80 | 75 | 91 | 89 | 90 |
| section | | | | | | | | |
| hardness | | | | | | | | |
| (IRHD) | | | | | | | | |
| Rear surface | 70 | ← | ← | ← | ← | ← | ← | ← |
| section | | | | | | | | |
| hardness | | | | | | | | |
| (IRHD) | | | | | | | | |
| Durability | 200k | 240k | 250k | 240k | 200k | 245k | 245k | 240k |
| evaluation | | | | | | | | |

| | Example 29 | Example 30 | Example 31 | Example 32 | Example 33 | Example 34 | Example 35 | Example 36 |
|---|---|---|---|---|---|---|---|---|
| Kind of | 1-Propenyl | Linalyl | Phenyl | p-Pentylphenyl | 2′,4′- | Isobutyl | Isobutyl | Isobutyl |
| curing | 3,5-diamino- | 3,5-diamino- | 3,5-diamino- | 3,5-diamino- | Dichlorophenyl | 3,5-diamino- | 3,5-diamino- | 3,5-diamino- |
| agent for | 4-chloro- | 4-chloro- | 4-chloro- | 4-chloro- | 3,5-diamino- | benzoate/ | 4-methyl- | 4-chloro- |
| abutting | benzoate/ | benzoate/ | benzoate/ | benzoate/ | 4-chloro- | TMP | benzoate/ | methylbenzoate/ |
| section | TMP | TMP | TMP | TMP | benzoate/ | | TMP | TMP |
| | | | | | TMP | | | |
| Curing | 50/50 | 50/50 | 50/50 | 50/50 | 50/50 | 50/50 | 50/50 | 50/50 |
| agent | | | | | | | | |
| ratio for | | | | | | | | |
| abutting | | | | | | | | |
| section | | | | | | | | |
| Abutting | 91 | 88 | 91 | 89 | 90 | 90 | 89 | 89 |
| section | | | | | | | | |
| hardness | | | | | | | | |
| (IRHD) | | | | | | | | |
| Rear surface | 70 | ← | ← | ← | ← | ← | ← | ← |
| section | | | | | | | | |
| hardness | | | | | | | | |
| (IRHD) | | | | | | | | |
| Durability | 245k | 240k | 240k | 240k | 240k | 240k | 240k | 240k |
| evaluation | | | | | | | | |

| | | | | | Comparative | Comparative | Comparative |
|---|---|---|---|---|---|---|---|
| | Example 37 | Example 38 | Example 39 | Example 40 | Example 4 | Example 5 | Example 6 |
| Kind of | Isobutyl | Isobutyl | Isobutyl | Isobutyl | 1,4- | 3,5- | 2,2′-3,3′- |
| curing | 3,5-diamino- | 3,5-diamino- | 3,5-diamino- | 3,5-diamino- | Butanediol/ | Dimethylthio-2,4- | Tetrachloro-4,4′- |
| agent for | 4-chloro- | 4-chloro- | 4-chloro- | 4-chloro- | TMP | toluenediamine/ | diaminodiphenyl |
| abutting | benzoate/ | benzoate/ | benzoate/ | benzoate/ | | TMP | methane/ |
| section | TMP | TME | pentaerythritol | dipentaerythritol | | | TMP |
| Curing | 50/50 | 50/50 | 50/50 | 50/50 | 50/50 | 50/50 | 50/50 |
| agent | | | | | | | |
| ratio for | | | | | | | |
| abutting | | | | | | | |
| section | | | | | | | |
| Abutting | 91 | 91 | 88 | 87 | 72 | 85 | 87 |
| section | | | | | | | |
| hardness | | | | | | | |
| (IRHD) | | | | | | | |
| Rear surface | 70 | ← | ← | ← | ← | ← | ← |
| section | | | | | | | |
| hardness | | | | | | | |
| (IRHD) | | | | | | | |
| Durability | 240k | 170k | 150k | 130k | 60k | 75k | 70k |
| evaluation | | | | | | | |

Compared with Comparative Examples 1 to 3, which were conventional heat-curable polyurethanes, the heat-curable polyurethane urea for which the diaminobenzoic acid ester of the present invention was used was excellent in terms of durability. Particularly, among the diaminobenzoic acid esters, isobutyl 3,5-diamino-4-chlorobenzoate had the most favorable durability. In addition, in a case where an alcohol-based curing agent was used in combination, 1,1,1-trimethylolpropane had the most favorable durability.

The abutting section and the rear surface section were composed of resins having different compositions, whereby it was possible to further enhance the durability.

1. An elastic body for blades,
wherein an abutting section comprises a heat-curable polyurethane urea that is a reaction product of at least a polyol, a polyisocyanate, and a curing agent including a diaminobenzoic acid ester indicated by the following general formula (1), 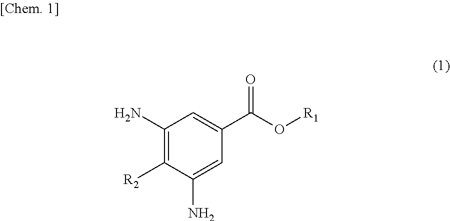
(in the formula, R₁ indicates a linear or branched alkyl group having 1 to 12 carbon atoms that may be substituted with a halogen atom, a linear or branched unsaturated hydrocarbon group having 3 to 10 carbon atoms that may be substituted with a halogen atom, or a phenyl group that may be substituted with a linear or branched alkyl group having 1 to 4 carbon atoms or a halogen atom, and
R₂ indicates a hydrogen atom, a halogen atom or a linear or branched alkyl group having 1 to 4 carbon atoms that may be substituted with a halogen atom).

2. The elastic body for blades according to claim 1,
wherein R₂ is a chlorine atom or a methyl group.

3. The elastic body for blades according to claim 1,
wherein the diaminobenzoic acid ester is isobutyl 3,5-diamino-4-chlorobenzoate indicated by the following general formula (2),

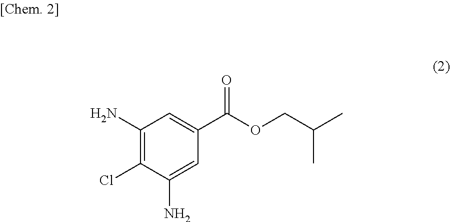

4. The elastic body for blades according to claim 1, comprising, as the curing agent:
a polyhydric alcohol.

5. The elastic body for blades according to claim 4, comprising, as the polyhydric alcohol:
trimethylolpropane.

6. The elastic body for blades according to claim 4,
wherein a mole ratio (—NH₂:—OH) between active hydrogen groups in the diaminobenzoic acid ester and the polyhydric alcohol is within a range of 95 to 5:5 to 95.

7. The elastic body for blades according to claim 1,
wherein a rear surface section comprises any of a heat-curable polyurethane urea, a heat-curable polyurethane and a heat-curable polyurea having a different composition from the abutting section.

8. A cleaning blade for electrophotographic devices,
wherein the elastic body for blades according to claim 1 is mounted in a support member.
